(19) United States
(12) Patent Application Publication
(10) Pub. No.: US 2010/0287708 A1
(43) Pub. Date: Nov. 18, 2010

(54) TRANSPARENT MATTRESS

(76) Inventor: Timothy W. Shelby, High Point, NC (US)

Correspondence Address: MACCORD MASON PLLC, 300 N. GREENE STREET, SUITE 1600, P. O. BOX 2974, GREENSBORO, NC, 27402, US

(21) Appl. No.: 12/466,452

(22) Filed: May 15, 2009

(51) Int. Cl. A47C 27/00; B23P 17/04

(52) U.S. Cl. 5/737; 29/428

(57) ABSTRACT

A mattress having a nonwoven core and a transparent cover is shown and described. Typically, the nonwoven core is configured to improve visualization of an object positioned within the mattress from at least one side of the mattress. Invention embodiments also include methods of making mattresses. A typical embodiment includes obtaining a nonwoven core and covering the nonwoven core with a transparent cover.

### FIELD

The present disclosure relates generally to mattresses, and more particularly to transparent mattresses and their method of manufacture.

### BACKGROUND

Mattresses for sleeping on are known in the art and are used in a variety of environments. In some environments, such as prisons and jails, mattresses are also used to hide dangerous or banned items, e.g., weapons or drugs. Some have attempted to address this problem using various methods, such as disassembling the mattress or searching for scent using dogs. Some have also tried air mattresses having transparent bladders. Applicant believes, however, that existing solutions have a variety of problems for a variety of reasons. It is to these, and additional, problems that the current invention is directed. Embodiments of the invention provide numerous other benefits as well, including providing a comfortable mattress and providing a mattress for improved sanitation.

### SUMMARY

By way of summary, the invention is directed to, inter alia, mattresses. A typical embodiment includes a mattress having a nonwoven core and a transparent cover. The nonwoven core is often configured to improve visualization of an object positioned within the mattress from at least one side of the mattress. In many embodiments, the core will have a void volume % of about 85% to about 97%, which facilitates improved visualization.

Invention embodiments also include methods of making mattresses. A typical embodiment includes obtaining a nonwoven core and covering the nonwoven core with a transparent cover. Because of its novel construction and function, obtaining the core will often include forming the core. The core may be formed by creating a polymer resin and forming at least one fiber from the resin into a web, e.g. by entangling. More typically the web is made from a plurality of fibers. The resultant web is then bonded, usually by exposure to heat, pressure, or both, to define the core.

The above summary was intended to summarize certain embodiments of the present invention. Mattresses and methods of the present invention will be set forth in more detail in the figures and detailed description below. It is apparent that while the invention provide solutions to the problems noted above, as well as additional problems, it is not limited by the various solutions it provides. It should also be clear that the detailed description below does not limit the present invention, the scope of which should be properly determined by the appended claims. It should also be clear that in other embodiments, the invention is directed to other products, e.g., cushions, pillows, etc.

### BRIEF DESCRIPTION OF THE FIGURES

FIG. 1 shows a mattress according to the invention;

FIG. 2 shows a cut-away side view of the mattress from FIG. 1;

FIG. 3 shows side view of a mattress containing an object within the mattress;

FIG. 4 shows a perspective view of a mattress containing an object;

FIG. 5 illustrates a method according to one embodiment of the invention; and

FIG. 6 illustrates other steps of a method according to the invention.

### DETAILED DESCRIPTION OF TYPICAL EMBODIMENTS

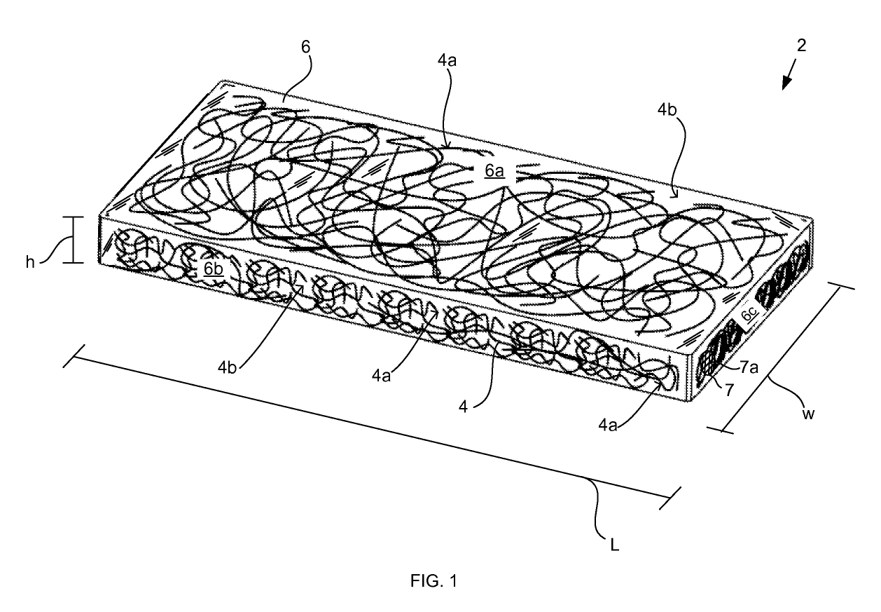

FIG. 1 shows mattress 2, which is illustrative of various embodiments of the invention. Mattress 2 can be any of a variety of sizes, but will often be similar in size to conventional mattresses. For example, typical embodiments will have a length L of about 50 to about 90 inches, more typically, about 70 to 80 inches; a width W of about 25 to about 75 inches, more typically about 35 to about 45 inches; and a height H of about 1 to about 10 inches, more typically about 2 to about 8 inches.

Mattress 2 includes porous nonwoven core 4 and transparent cover 6. Core 4 will typically have dimensions similar to the dimensions of the mattress embodiment in which it is contained. For example, different core embodiments will have a length L of about 50 to about 90 inches, more typically, about 70 to 80 inches; a width W of about 25 to about 75 inches, more typically about 35 to about 45 inches; and a height H of about 1 to about 10 inches, more typically about 2 to about 8 inches.

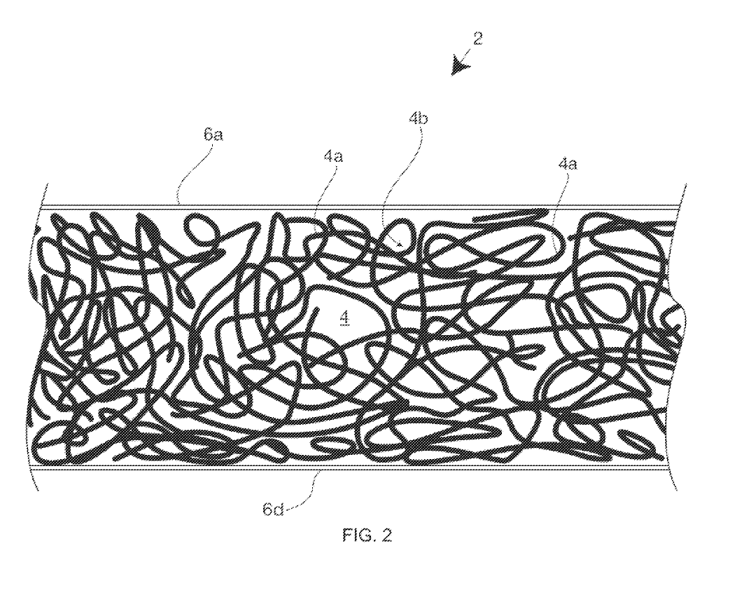

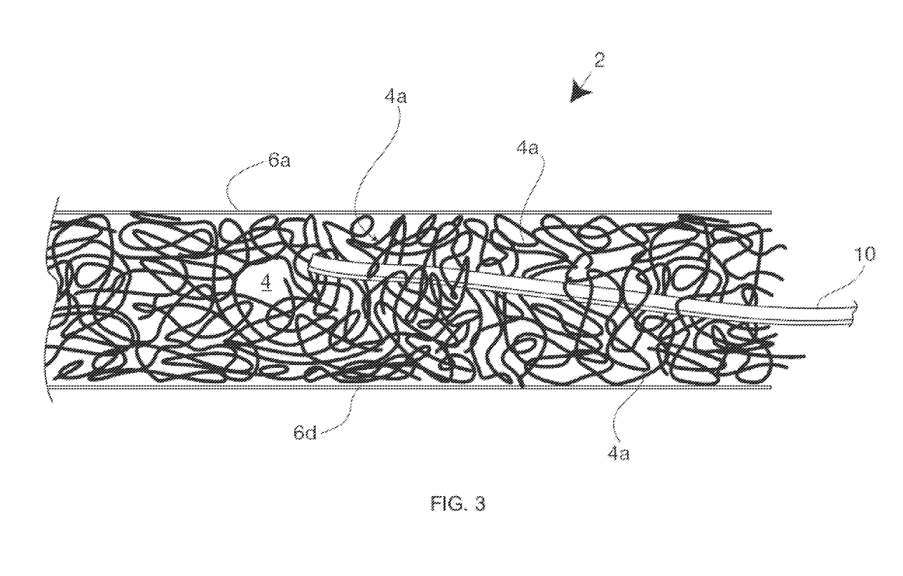

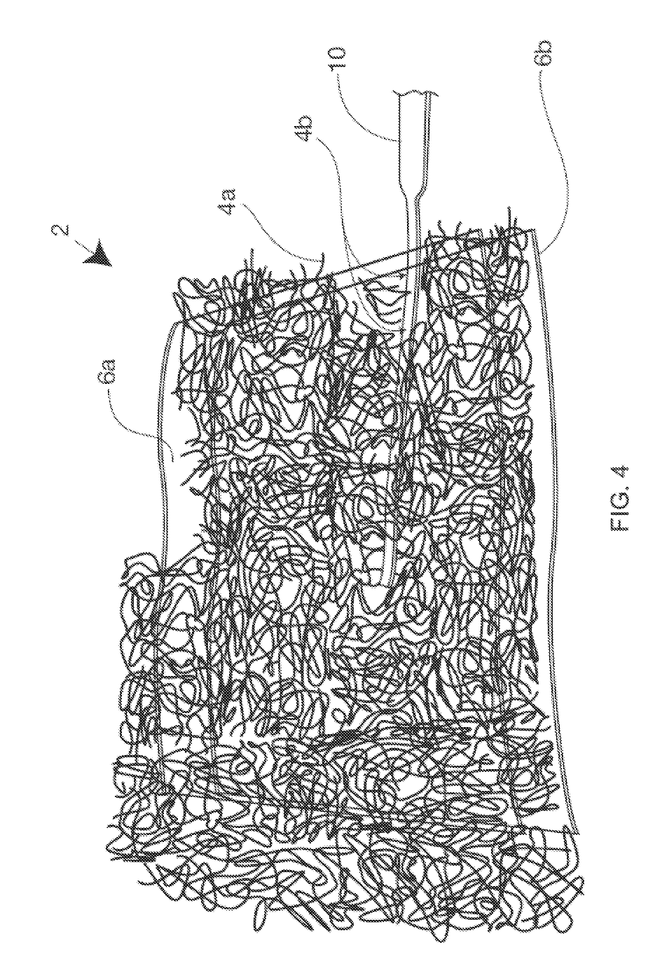

FIG. 2 shows a cross-section of mattress 2, including a close-up of core 4. Referring to both FIGS. 1 and 2, core 4 includes fibers 4a that are entangled and bonded together to define the core. Fibers 4a are representative of a plurality of entangled fibers used to define the core, and also representative of a single, long fiber entangled to define the core. Typically, a plurality of fibers will be used. Core 4 also includes a plurality of pores 4b defined by fibers 4a. As mentioned above, one of the benefits provided by the invention is that it improves visualization of items placed within the mattress, thus making it more difficult to hide weapons or contraband. Pores 4b facilitate, at least in part, the visualization of objects contained within the mattress. FIG. 3, for example, shows a view similar to FIG. 2 with the addition of object 10 (a letter opener representative of a weapon or contraband) positioned in core 4. FIG. 4 shows a perspective view of an object positioned in a mattress. As seen in FIGS. 3 and 4, object 10 is readily detectable upon visual inspection of the mattress.

Visualization of objects is achievable, at least in part, by the relatively high porosity of the core. In typical embodiments, core fibers are bonded together to create a void volume % of about 85% to about 97%, more typically, about 90% to about 95%. As calculated, void volume %=(weight of the internal phase)−(weight of core+weight of internal phase). Water was used as the internal phase for the measurements contained herein. The pore size and pore connectivity may vary from embodiment to embodiment, but in typical embodiments, either or both will be sufficient to allow visualization of an object having a length of about 15 cm, a width of about 1 cm, and thickness of about 0.2 cm, from at least one side of the mattress when that object is placed in the core. More typically, the pore size or connectivity will be sufficient to allow visualization of an object having a length of about 5 cm, a width of about 1 cm, and thickness of about 0.2 cm, from at least one side of the mattress when that object is placed in the core.

Another feature of the core is that it typically has a firmness sufficient to allow it to function as a mattress. Firmness may be determined based on Indentation Load Deflection (ILD). ILD is the amount of force (in pounds) required to compress an indentor foot having a surface area of 50 in² into a core sample having a surface area of at least 24 in² to a depth of 25 percent of the core's initial height. For example, for a core sample having a height of 4 inches, the ILD is the amount of force required to depress the indentor foot 1 inch. ILD may vary from embodiment to embodiment, but typical embodiments will have an ILD ranging from about 10 to about 50. Embodiments may be formed with varying degrees of firmness, for example, from extra soft to extra firm. Additionally, some embodiments may have different ILDs at different parts of the core. For example, the core may be configured such that the head of the mattress will have a higher ILD and the foot of the mattress will have a lower ILD. Exemplary ILDs for various embodiments may include an ILD of about 15 to about 20, about 20 to about 25, about 25 to about 30, about 30 to about 35, about 35 to about 40, about 45 to about 50, etc.

In many embodiments, the core will have both a void volume % as discussed above and an ILD within the ranges disclosed.

Fiber diameter in the core may vary from embodiment to embodiment. Typically, fibers will have a thickness, e.g., diameter, of about 0.5 mm to about 10 mm. More typically, thickness will be about 1 mm to about 5 mm. In many embodiments, fiber thickness will be about 1 mm to about 2 mm.

Cross sectional shape may also vary from embodiment to embodiment. Typically, fibers will have a circular cross sectional shape. More typically, fibers will have a tubular or hollow shape, which Applicant believes imparts, for at least some embodiments, additional bond flexibility at fiber-fiber bonding sites. Other embodiments include other cross sectional shapes, e.g., square, triangular or rectangular, or some combination thereof. It should also be noted that within a given core, various combinations of any of the above fibers may be used.

Fibers may be bonded together in a variety of ways, e.g., mechanically, thermally chemically, or combinations thereof. In typical embodiments, bonding will include thermal bonding, e.g., melt-bonding by exposing the core to heat after fiber formation such that fibers are re-melted and bond at fiber-fiber points of contact. In some embodiments fibers may be sufficiently molten after formation such that entanglement creates sufficient bonding, without the requirement of additional heat.

In many embodiments, fibers will include thermoplastic fibers. A variety of thermoplastics are known in the art, but typical thermoplastics include polyurethane, PVC, or mixtures thereof. Other thermoplastics which may be suitable include acrylonitrile butadiene styrene (ABS), acrylic (PMMA), celluloid, cellulose acetate, ethylene-vinyl acetate (EVA), ethylene vinyl alcohol (EVOH), fluoroplastics (PTFE, including FEP, PFA, CTFE, ECTFE, ETFE), ionomers, KYDEX (acrylic/PVC alloy), liquid crystal polymer (LCP), polyacetal (POM or Acetal), polyacrylates (Acrylic), polyacrylonitrile (PAN or Acrylonitrile), polyamide (PA or Nylon), polyamide-imide (PAI), polyaryletherketone (PAEK or Ketone), Polybutadiene (PBD), Polybutylene (PB), Polybutylene terephthalate (PBT), Polycaprolactone (PCL), Polychlorotrifluoroethylene (PCTFE), Polyethylene terephthalate (PET), Polycyclohexylene dimethylene terephthalate (PCT), Polycarbonate (PC), Polyhydroxyalkanoates (PHAs), Polyketone (PK), Polyester, Polyethylene (PE), Polyetheretherketone (PEEK), Polyetherketoneketone (PEKK), Polyetherimide (PEI), Polyethersulfone (PES), Polyethylenechlorinates (PEC), Polyimide (PI), Polylactic acid (PLA), Polymethylpentene (PMP), Polyphenylene oxide (PPO), Polyphenylene sulfide (PPS), Polyphthalamide (PPA), Polypropylene (PP), Polystyrene (PS), Polysulfone (PSU), Polytrimethylene terephthalate (PTT), Polyvinyl acetate (PVA), Polyvinylidene chloride (PVDC), Styrene-acrylonitrile (SAN), thermoplastic olefin (TPO), or chlorosulfonated polyethylene synthetic rubber (CSPE).

In typical embodiments, the fibers will be at least slightly opaque. As used herein slightly opaque means having less light transmittance than that of the cover. Slightly opaque is also inclusive of translucent fibers and opaque fibers. Often, in some embodiments fibers will be slightly opaque and at least slightly absorptive of light (e.g., non-glaring). Applicant surprisingly discovered that the use of slightly opaque fibers for core construction improved the visibility of objects positioned within the core, e.g., object 10 mentioned above, relative to transparent fibers or fibers having a transparency similar to the cover. Not to be limited to a mechanism, but Applicant believes that a transparent cover in combination with transparent fibers creates an abundance of reflected and/or refracted light within the mattress that made object visualization more difficult.

Because of their large pore size, typically, cores of the invention are non-filtering and should not be confused with non-woven filters. As used herein, “filtering” refers to the substantial increase in differential pressure (ΔP) observed after at least about 30 minutes of water flowing at 2.5 gallons per minute (gpm) and containing 200 parts per million (ppm) of a particulate contaminate (having an average size of about 65 μm to about 200 μm) is passed through a 10 inch square surface area of the core having a thickness of about 2 inches. Additionally, nonwoven cores should not be confused with foams, e.g., MEMORY FOAMS, sometimes used in mattress construction. Applicant's nonwoven core is both structurally and functionally distinct from existing foams.

Referring back to FIGS. 1 and 2, cover 6 is transparent, meaning that it can be seen through. Typically, cover 6 will be clear. A variety of materials may be used to construct covers of the invention, including the thermoplastics listed above, e.g., PLA, polyurethane, etc. In many embodiments, covers will include PVC sheeting. Cover thickness may vary from embodiment to embodiment, but typical thicknesses will be about 0.1 mm to about 5 mm. More typically, cover thickness will be about 0.2 mm to about 1 mm. In many embodiments, cover thickness will be about 0.5 mm.

As seen best in FIG. 1, covers typically include top surface 6a covering the top surface of the core; bottom surface 6d (see FIG. 2) covering the bottom surface of the core, and side surfaces 6b and 6c (opposite sides not shown) covering the sides of the core. Most typically, covers will include at least one vent, such as vent 7, positioned in a cover surface to facilitate air flow into and out of the mattress. Vents are often positioned in at least one side of the cover as shown, to facilitate air flow during use.

In many embodiments, covers will also be sealed at their joints, e.g., hermetically sealed. Most sealed embodiments will also include vents to facilitate airflow into and out of the mattress. Typically, vents will also include a filter device 7a to reduce the flow of undesirable material, e.g., dirt, insects, bacteria or viruses, into the core of the mattress, for improved sanitation. Vent filtration specifications may vary from embodiment to embodiment.

A variety of mattress embodiments will be readily apparent from the above description. The above teachings could also be applied to other end products, e.g., transparent pillows, cushions, etc., and such are considered to be within the scope of the present invention.

The instant disclosure is also directed to methods of making mattresses.

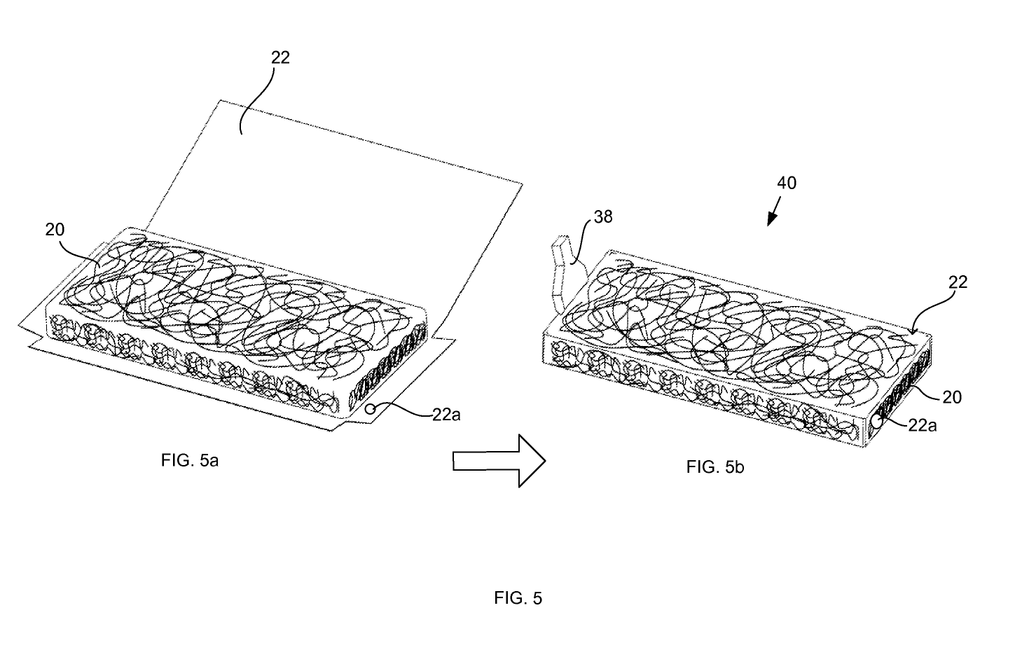

FIG. 5 is illustrative of methods of making mattresses according to typical embodiments of the invention. FIG. 5a represents obtaining a nonwoven core 20, which may be any of the cores described above, and covering that core with cover 22, which may be any of the covers described above. Typically, covering includes die-cutting a blank to create a cover pre-form. The cover pre-form is then folded to cover the mattress. Covering may be achieved in a variety of other ways, e.g., cutting pieces sized for a side or surface and joining the pieces. At least one vent hole 22a will also typically be cut into cover 22. Oftentimes vents will include a filter with a pore size sufficient to block microorganisms, e.g., small insects, bacteria, fungi or their parts, or viruses from entering the core.

FIG. 5b illustrates one embodiment of a covered mattress 40, and also represents securing the cover. Typically, securing includes sealing the cover, e.g., at its joints, using sealer 38. Sealing may be performed by a variety of methods including radio frequency heat sealing, hot gas welding, freehand welding, speed tip welding, extrusion welding, contact welding, hot plate welding, ultrasonic welding, friction welding, laser welding, and solvent welding. Most typically, sealing will be performed by radio frequency heat sealing. In other embodiments, sealing includes using other forms of fastening, e.g. stitching, buttons, hook and loop, etc.

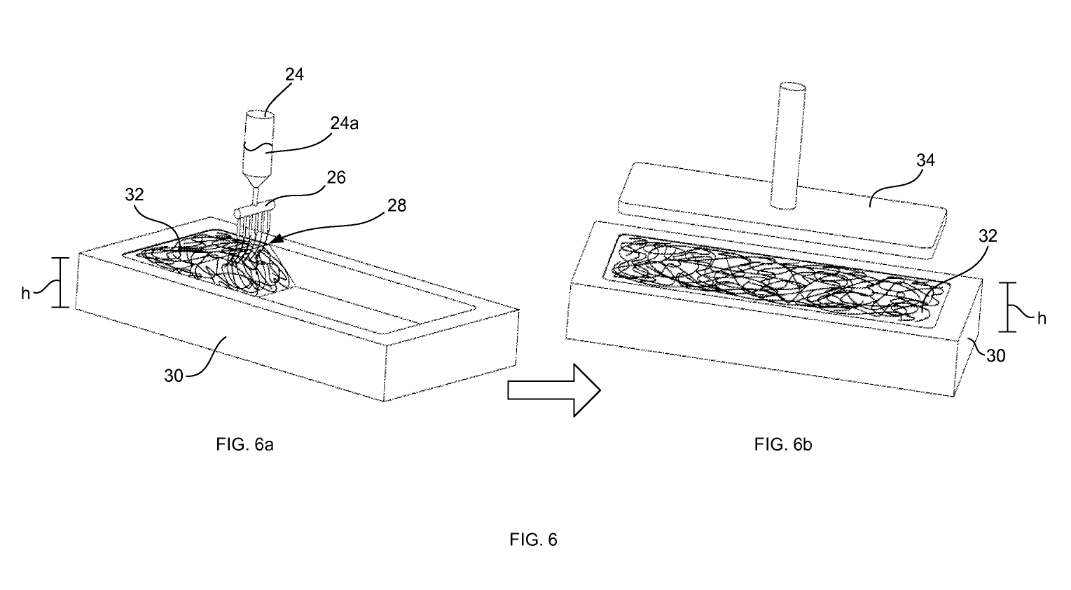

FIG. 6 represents forming the nonwoven core, which is commonly how the nonwoven core is obtained. FIG. 6a illustrates creating a polymer resin 24a in tank 24. Resin 24a is typically created by heating a thermoplastic polymer, e.g., those described above, to liquid state. Resin 24a may be extruded through extruder 26 to create at least one fiber, and more typically, a plurality of fibers 28. Further, although a single extruder 26 is shown, embodiments may use multiple extruders.

Fibers 28 are formed into mold 30 to form a web 32 of fibers. Typically, fibers 28 are entangled by moving, e.g., oscillation, rotation or vibration, extruder 26 or mold 30, or both. Also, either the mold or the extruder may be moved relative to the other to fill the mold with the web. A variety of fiber extrusion rates may be used to create the core. These rates can be adjusted as needed depending on the thermopolymer or the size of the mold, for example, as needed to achieve the desired product. Using such configurations, webs can be formed to a variety of heights h, which will often be between about 4 inches to about 16 inches.

In many embodiments, mold 30 will have length and width dimensions similar to the desired dimensions of the finished mattress. In other embodiments, molds can be much larger than finished mattress and can be used to form core blanks that are cut to the desired size. Mold height may be greater then the height of the finished mattress, e.g. to facilitate web formation and compression.

Fiber cross section and thickness may be any of those previously described. Most typically, fibers will be extruded with a hollow cross section. The cross section will typically be from about 1 mm to about 2 mm. Additionally, resin 24a will also typically be configured to impart slight opacity to the ultimately formed fiber. For example, a pigment may be added to tank 24 or a tinted product may be formed into a resin. The benefits of slight opacity are discussed above.

After formation, webs are typically exposed to either heat or compression or a combination of both. FIG. 6b illustrates using both compression and heat. Compression is applied by foot 34, typically being sized to fit into the cavity created by mold 30. In other embodiments, compression could be applied by a roller press, or a heated roller. Often, compressing is performed such that the web 32 is compressed to about 10% to about 50% of its original height. Applicant believes that compression provides improved bonding of entangled fibers. Heating is may be performed by placing mold 30 into an oven. Temperatures used may vary from embodiment to embodiment, but will typically be sufficient to re-melt, at least partially, the fiber (e.g., at least the outermost layer of the fibers such that the fibers retain their fibrous form and entangled relationship). Re-melting will typically improve the bonding between entangled fibers. Other embodiments include other ways to compress or heat. For example, mold 30 may be such that it applies pressure from each side. Similarly, mold 30 may contain heating elements that heat. In other embodiments, additional heating may not be needed to provide sufficient bond formation. In some embodiments, compression may not be needed to provide sufficient bonding.

Numerous characteristics and advantages have been set forth in the foregoing description, together with details of structure and function. The disclosure, however, is illustrative only, and changes may be made in detail, especially in matters of shape, size, and arrangement of parts, within the principle of the invention, to the full extent indicated by the broad general meaning of the terms in which the general claims are expressed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

What is claimed is:

1 A mattress comprising:
a porous nonwoven core defined by at least one fiber, wherein said core has a height of about 1 inches to about 10 inches; and
a transparent cover covering said core.

2. The mattress of claim 1, wherein said core has a void volume % of about 85% to about 97%.

3. The mattress of claim 1, wherein said core has a void volume % of about 90% to about 95%.

4. The mattress of claim 1, wherein said core has an ILD of about 15 to about 50.

5. The mattress of claim 1, wherein said core has an ILD chosen from about 15 to about 20, about 20 to about 25, about 25 to about 30, about 30 to about 35, about 35 to about 40, or about 45 to about 50.

6. The mattress of claim 1, wherein said core has a void volume % of about 85% to about 95%, and an ILD of about 15 to about 50.

7. The mattress of claim 1, wherein said core has
a length chosen from about 50 inches to about 90 inches,
a width chosen from about 25 inches to about 75 inches, and
a height chosen from about 2 inches to about 8 inches.

8. The mattress of claim 1, wherein said at least one fiber include at least one thermoplastic fiber.

9. The mattress of claim 8, wherein said at least one thermoplastic fiber is chosen from polyurethane, PVC, or mixtures thereof.

10. The mattress of claim 8, wherein said at least one fiber includes hollow portions.

11. The mattress of claim 1, wherein said at least one fiber is entangled and bonded.

12. The mattress of claim 8, wherein said at least one fiber is melt-bonded to itself or at least another fiber.

13. The mattress of claim 1, wherein said at least one fiber has a thickness of about 0.5 mm to about 10 mm.

14. The mattress of claim 1, wherein said core is non-filtering.

15. The mattress of claim 1, wherein said at least one fiber is slightly opaque.

16. The mattress of claim 1, wherein said core has a top surface, a bottom surface, and a plurality of side surfaces, wherein said cover covers said top surface, said bottom surface and said side surfaces.

17. The mattress of claim 16, wherein said cover is hermetically sealed.

18. The mattress of claim 17, further including a vent positioned in said cover.

19. The mattress of claim 17, wherein said vent is positioned in at least one of said plurality of side surfaces.

20. The mattress of claim 16, wherein said vent includes a filter.

21. The mattress of claim 1, wherein said cover is PVC.

22. The mattress of claim 1, wherein said cover thickness is about 0.1 mm to about 5 mm.

23. A mattress having a length chosen from about 50 inches to about 90 inches, a width chosen from about 25 inches to about 75 inches, and a height chosen from about 1 inch to about 10 inches; said mattress comprising:
(a) a porous nonwoven core comprising at least one bonded fiber,
wherein said core has
a void volume % of about 85% to about 97%, and
an ILD of about 15 to about 50, and
wherein said fibers are slightly opaque and have a thickness about 0.5 mm to about 5 mm; and
(b) a transparent cover covering said core.

24. The mattress of claim 23, wherein said transparent cover is hermetically sealed and includes a vent positioned in a side of said mattress.

25. The mattress of claim 23, wherein said plurality of fibers include hollow portions.

26. A method of making a mattress comprising the steps of:
obtaining a nonwoven core comprising at least one mechanically interlocked fiber, said core having a height of about 1.5 inches to about 10 inches; and
covering said core with a transparent cover.

27. The method of claim 26, wherein said core is porous with a void volume % of about 85% to about 97%.

28. The method of claim 26, wherein said core has an ILD of about 15 to about 50.

29. The method of claim 26, wherein obtaining includes forming said nonwoven core.

30. The method of claim 26, wherein forming said nonwoven core includes creating a polymer resin capable of forming fibers; and
forming at least one fiber from said resin into a web having a height of about 4 inches to about 16 inches.

31. The method of claim 28, further including a step chosen from heating said web, compressing said web, and heating and compressing said web, thereby increasing the bond between said at least one fiber.

32. The method of claim 31, wherein said heating includes heating to a temperature sufficient to soften the outer layer of said at least one fiber, and wherein said compressing includes compressing by about 10% to about 50%.

33. The method of claim 30, wherein said at least one fiber is formed with a thickness of about 0.5 mm to about 10 mm.

34. The method of claim 30, wherein said at least one fiber is formed with a hollow cross section.

35. The method of claim 30, wherein said creating said resin includes creating a resin configured to form fibers that are at least slightly opaque.

36. The method of claim 30, wherein said resin is a thermoplastic resin.

37. The method of claim 36, wherein said thermoplastic resin is chosen from polyurethane, PVC, or mixtures thereof.

38. The method of claim 26, wherein said covering includes sealing said cover.

39. The method of claim 38, further including positioning a vent in said transparent cover.

40. A method of making a mattress comprising the steps of:
forming a nonwoven core, wherein forming includes bonding at least one fiber to create a porous core having
a void volume % of about 85% to about 97%, and
an ILD of about 15 to about 50; and
covering said nonwoven core with a transparent cover.

41. The method of claim 40,
wherein said forming said nonwoven core includes
creating a polymer resin capable of forming fibers, and
forming at least one slightly opaque fiber from said resin into a web having a height of about 4 inches to about 16 inches; and
wherein said bonding includes heating said web, compressing said web, or heating and compressing said web.
